(19) United States
(12) Patent Application Publication
(10) Pub. No.: US 2015/0015995 A1
(43) Pub. Date: Jan. 15, 2015

(54) HARD DISK DRIVE SPINDLE MOTOR CUP

(71) Applicant: HGST Netherlands B.V., Amsterdam (NL)

(72) Inventors: Kimihiko Sudo, Yokohama-shi (JP); Mutsuro Ohta, Yokohama-shi (JP); Yasuhiro Sakata, Fujisawa-shi (JP); Kouki Uefune, Hiratsuka-shi (JP)

(21) Appl. No.: 13/940,167

(22) Filed: Jul. 11, 2013

(51) Int. Cl. G11B 19/20

(52) U.S. Cl. CPC G11B 19/2009
USPC 360/99.16; 29/603.03

(57) ABSTRACT

Approaches to maintaining hard disk drive spindle motor rigidity and performance in low profile HDD devices comprise using an enclosure base with a bottom opening in which a separate motor cup is fitted and configured to support the spindle motor. The motor cup may then be fabricated using a different material than the enclosure base, such as a material having a higher modulus of elasticity than that of the base. Furthermore, a magnetic motor cup may be used to substitute for the thrust yoke typically used with conventional spindle motors.

### FIELD OF THE INVENTION

Embodiments of the invention relate generally to hard disk drives and more particularly to low profile hard disk drives.

### BACKGROUND

A hard-disk drive (HDD) is a non-volatile storage device that is housed in a protective enclosure and stores digitally encoded data on one or more circular disks having magnetic surfaces. When an HDD is in operation, each magnetic-recording disk is rapidly rotated by a spindle system. Data is read from and written to a magnetic-recording disk using a read/write head which is positioned over a specific location of a disk by an actuator.

Typically, the spindle motor is attached directly to the enclosure base plate, which is most commonly made of an aluminum alloy. The spindle motor is attached to the base plate via a supporting portion of the base plate that has an annular upraised portion in which a base portion of the spindle motor is inset and attached to the base plate via a screw, surrounded by an annular seat portion in which rotating motor components are positioned. Spindle motors need a certain degree of rigidity along their axis of rotation for motor performance as well as for head positioning accuracy purposes.

However, the continuing evolution of HDDs has led to HDDs having thinner and thinner profiles. For example, the evolution of HDD profiles included 9.5 mm (height) HDDs, then 7 mm HDDs, and on to even thinner HDDs, while at the same time increasing the storage capacity and maintaining standard form factors (i.e., the “footprint” of an HDD) for installation in computing and data storage devices. Therefore, there are continuous design challenges associated with the evolution of HDDs to thinner profiles and more capacity, such as spatial challenges due to decreasing volumes within which to enclose HDD components.

### SUMMARY OF EMBODIMENTS OF THE INVENTION

Embodiments of the invention are directed to maintaining or improving hard disk drive (HDD) spindle motor rigidity and performance in low profile HDD devices.

According to an embodiment, an enclosure base for an HDD comprises a bottom opening in which a separate motor cup is fitted and configured to support the spindle motor. Thus, the motor cup may be comprised of a different material than the enclosure base, such as a material having a higher modulus of elasticity than that of the base. For example, stainless steel may be used to form the motor cup, in contrast with the enclosure base which is typically formed from an aluminum alloy or a synthetic material.

According to an embodiment, a magnetic stainless steel is used to form the motor cup, which is positioned opposite a spindle motor rotor magnet and generates magnetic force between the rotor magnet and the motor cup. Consequently, the magnetic motor cup assists in balancing a lifting force generated by the rotating parts of the spindle motor by generating an axial downward magnetic force in conjunction with the rotor magnet. Therefore, the magnetic motor cup may be used to substitute for the thrust yoke typically used with conventional spindle motors, and the HDD part count is reduced.

Embodiments discussed in the Summary of Embodiments of the Invention section are not meant to suggest, describe, or teach all the embodiments discussed herein. Thus, embodiments of the invention may contain additional or different features than those discussed in this section.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a plan view of a hard disk drive (HDD), according to an embodiment of the invention;

FIG. 2 is an exploded perspective view of HDD components, according to an embodiment of the invention; and

FIG. 3 is cross-sectional view of HDD components, according to an embodiment of the invention.

### DETAILED DESCRIPTION

Approaches to the configuration and use of a spindle motor cup separate from a hard disk drive enclosure base plate are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

### Physical Description of Illustrative Embodiments of the Invention

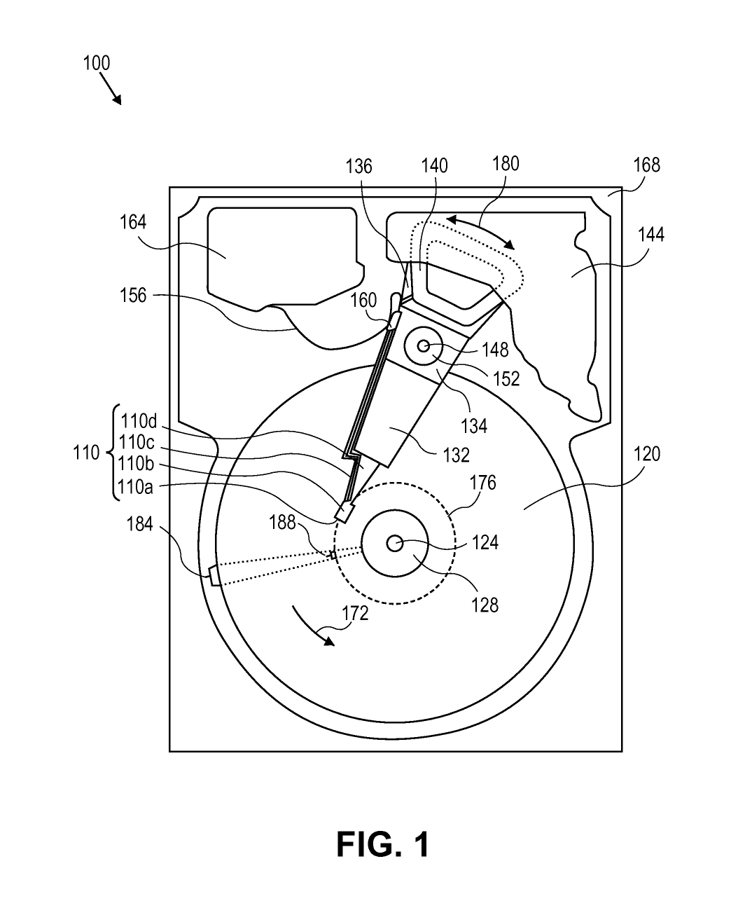

Embodiments of the invention may be used in the context of a hard-disk drive (HDD). Therefore, in accordance with an embodiment of the invention, a plan view of a HDD 100 is shown in FIG. 1. FIG. 1 illustrates the functional arrangement of components of the HDD including a slider 110b that includes a magnetic-reading/recording head 110a. Collectively, slider 110b and head 110a may be referred to as a head slider. The HDD 100 includes at least one head gimbal assembly (HGA) 110 including the head slider, a lead suspension 110c attached to the head slider, and a load beam 110d attached to the lead suspension 110c. The HDD 100 also includes at least one magnetic-recording disk 120 rotatably mounted on a spindle 124 and a drive motor (not visible) attached to the spindle 124 for rotating the disk 120. The head 110a includes a write element and a read element for respectively writing and reading information stored on the disk 120 of the HDD 100. The disk 120 or a plurality (not shown) of disks may be affixed to the spindle 124 with a disk clamp 128.

The HDD 100 further includes an arm 132 attached to the HGA 110, a carriage 134, a voice-coil motor (VCM), or actuator, that includes an armature 136 including a voice coil 140 attached to the carriage 134; and a stator 144 including a voice-coil magnet. The armature 136 of the VCM is attached to the carriage 134 and is configured to move the arm 132 and the HGA 110 to access portions of the disk 120 being mounted on a pivot-shaft 148 with an interposed pivot-bearing assembly 152. In the case of an HDD having multiple disks, or platters as disks are sometimes referred to in the art, the carriage 134 is called an “E-block,” or comb, because the carriage is arranged to carry a ganged array of arms that gives it the appearance of a comb.

Electrical signals, for example, current to the voice coil 140 of the VCM and write signal to and read signal from the head 110a, are provided by a flexible interconnect cable 156 (“flex cable”). Interconnection between the flex cable 156 and the head 110a may be provided by an arm-electronics (AE) module 160, which may have an on-board pre-amplifier for the read signal, as well as other read-channel and write-channel electronic components. The AE 160 may be attached to the carriage 134 as shown. The flex cable 156 is coupled to an electrical-connector block 164, which provides electrical communication through electrical feedthroughs (not shown) provided by an HDD housing 168. The HDD housing 168 in conjunction with an HDD cover provides a sealed, protective enclosure for the information storage components of the HDD 100.

Other electronic components, including a disk controller and servo electronics including a digital-signal processor (DSP), provide electrical signals to the drive motor, the voice coil 140 of the VCM and the head 110a of the HGA 110. The electrical signal provided to the drive motor enables the drive motor to spin providing a torque to the spindle 124 which is in turn transmitted to the disk 120 that is affixed to the spindle 124 by the disk clamp 128; as a result, the disk 120 spins in a direction 172. The spinning disk 120 creates a cushion of air that acts as an air-bearing on which the air-bearing surface (ABS) of the slider 110b rides so that the slider 110b flies above the surface of the disk 120 without making contact with a thin magnetic-recording medium of the disk 120 in which information is recorded.

The electrical signal provided to the voice coil 140 of the VCM enables the head 110a of the HGA 110 to access a track 176 on which information is recorded. Thus, the armature 136 of the VCM swings through an arc 180 which enables the HGA 110 attached to the armature 136 by the arm 132 to access various tracks on the disk 120. Information is stored on the disk 120 in a plurality of stacked tracks arranged in sectors on the disk 120, for example, sector 184. Correspondingly, each track is composed of a plurality of sectored track portions, for example, sectored track portion 188. Each sectored track portion 188 is composed of recorded data and a header containing a servo-burst-signal pattern, for example, an ABCD-servo-burst-signal pattern, information that identifies the track 176, and error correction code information. In accessing the track 176, the read element of the head 110a of the HGA 110 reads the servo-burst-signal pattern which provides a position-error-signal (PES) to the servo electronics, which controls the electrical signal provided to the voice coil 140 of the VCM, enabling the head 110a to follow the track 176. Upon finding the track 176 and identifying a particular sectored track portion 188, the head 110a either reads data from the track 176 or writes data to the track 176 depending on instructions received by the disk controller from an external agent, for example, a microprocessor of a computer system.

### Introduction

As discussed, there are continuous design challenges associated with the evolution of HDDs to thinner profiles and more capacity, such as spatial challenges due to decreasing volumes within which to enclose HDD components. Furthermore, spindle motors need a certain degree of rigidity along their axis of rotation for motor performance as well as for head positioning accuracy purposes. Therefore, maintaining the motor rigidity in the environment of a thinner, low profile HDD is desirable, and embodiments of the invention are directed thereto.

### Spindle Motor Cup

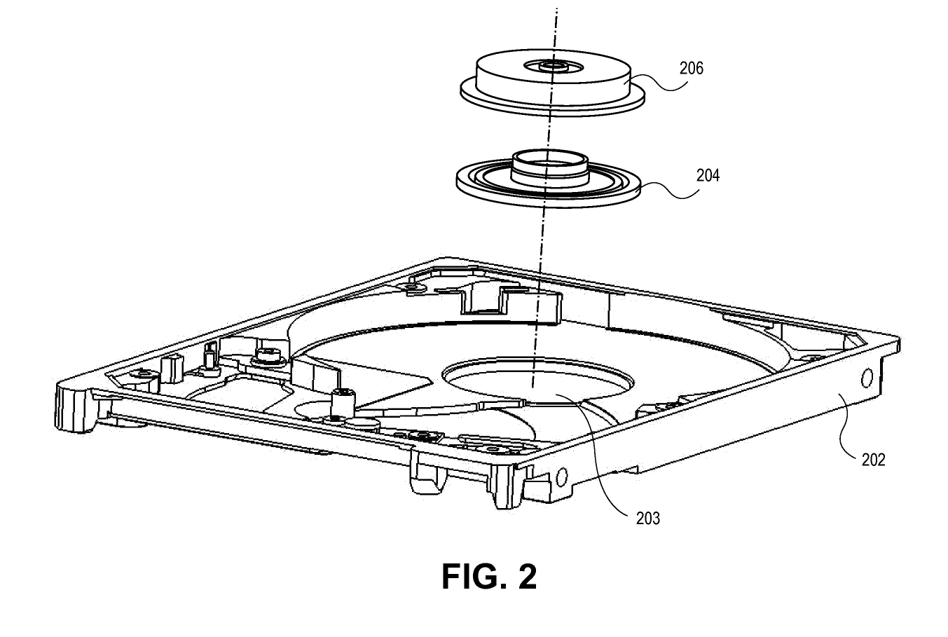

FIG. 2 is an exploded perspective view of hard disk drive (HDD) components, according to an embodiment of the invention. FIG. 2 illustrates a HDD enclosure base 202 that comprises an opening 203. A motor cup 204 is fitted into the opening 203 for attachment to the enclosure base 202. Motor cup 204 serves as supporting structure for installation of a spindle motor 206 into the enclosure and onto the enclosure base 202. The manner in which the motor cup 204 is affixed to the enclosure base 202 may vary from implementation to implementation. For example, motor cup 204 may be fastened to the enclosure base 202 using fasteners, may be adhered with adhesive or welded onto the enclosure base 202, may be press fit into the opening 203, or the like.

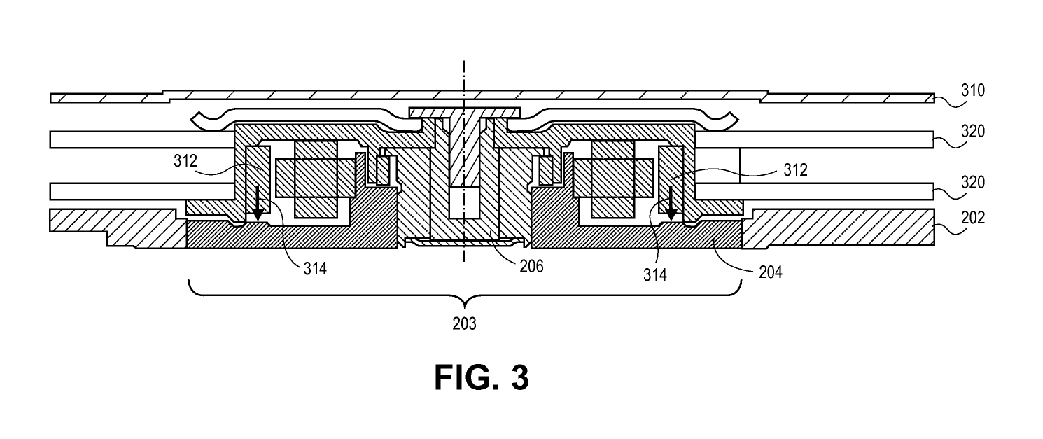

FIG. 3 is cross-sectional view of HDD components, according to an embodiment of the invention. FIG. 3 illustrates the HDD enclosure base 202 that comprises the opening 203. The motor cup 204, which is a separate component from the enclosure base 202, is fitted into the opening 203 for attachment to the enclosure base 202, and is configured to support the spindle motor 206. One or more magnetic recording disks 320 (similar to disk 120 of FIG. 1) are affixed to the spindle motor 206 for rotation thereof. The HDD of FIG. 3 further comprises a top cover 310 for enclosing the HDD components.

Thus, in contrast to conventionally configured HDDs, the motor cup 204 is a separate component from the enclosure base 202. Consequently, the motor cup may be manufactured from a different material than the enclosure base 202. According to an embodiment, the motor cup 204 comprises a material having a higher modulus of elasticity than the material from which the enclosure base 202 is made. According to an embodiment, the motor cup 204 is at least primarily stainless steel. Use of stainless steel for the motor cup 204 is in contrast with the typical use of an aluminum alloy for the enclosure base 202, and provides a more rigid supporting structure for the spindle motor 206 than would an aluminum supporting structure having the same configuration. Consequently, in comparison with a conventional aluminum die cast enclosure base that includes a spindle motor support structure, use of the motor cup 204 leads to a reduction in the operational distortion and the amount of displacement of such spindle motor supporting structure.

Conventional HDDs may include an annular thrust yoke formed from a ferromagnetic material and positioned opposing the rotor magnet of the spindle motor, thereby generating a magnetically attractive force in the axial direction in between the thrust yoke and the rotor magnet, which balances with the rotor lifting pressure produced in the thrust bearing section and the hydrostatic bearing. This balancing stabilizes the thrust-direction support of the rotor, and eliminates excessive lift that would raise the rotor higher than necessary,

According to an embodiment, a magnetic material (e.g., magnetic stainless steel such as SUS430) is used to form motor cup 204. The motor cup 204 is positioned opposite a spindle motor rotor magnet 312 and generates magnetic force between the rotor magnet 312 and the motor cup 204. Consequently, the magnetic motor cup 204 assists in balancing a lifting force generated by the rotating parts of the spindle motor by generating an axial downward magnetic force 314 in conjunction with the rotor magnet 312. Therefore, the magnetic motor cup 204 may be used to substitute for the thrust yoke typically used with conventional spindle motors, and the HDD part count is reduced.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A hard disk drive (HDD), comprising:
an enclosure base having a bottom opening therethrough;
a magnetic-recording disk rotatably mounted on a spindle;
a spindle motor configured to rotate said spindle on which said magnetic-recording disk is mounted;
a head slider comprising a magnetic read/write head for writing data to and reading data from said magnetic-recording disk; and
a motor cup fitted within said bottom opening of said enclosure base and configured to support said spindle motor.

2. The HDD of claim 1, wherein said enclosure base is made of a first material and said motor cup is made of a second material that is different from said first material.

3. The HDD of claim 1, wherein said enclosure base is made of a first material and said motor cup is made of a second material that has a higher modulus of elasticity than said first material.

4. The HDD of claim 1, wherein said enclosure base is made at least primarily of aluminum and said motor cup is made at least primarily of steel.

5. The HDD of claim 1, wherein said motor cup is made at least primarily of a magnetic stainless steel.

6. The HDD of claim 4, not comprising a thrust yoke.

7. The HDD of claim 1, wherein said enclosure base is a separate part from said motor cup.

8. An enclosure base for a hard disk drive (HDD), comprising:
a bottom opening therethrough; and
a motor cup fitted within said bottom opening, affixed to said enclosure base, and configured to support a spindle motor.

9. The enclosure base of claim 8, wherein said enclosure base is made of a first material and said motor cup is made of a second material that is different from said first material.

10. The enclosure base of claim 8, wherein said enclosure base is made of a first material and said motor cup is made of a second material that has a higher modulus of elasticity than said first material.

11. The enclosure base of claim 8, wherein said motor cup is made at least primarily of steel.

12. The enclosure base of claim 8, wherein said motor cup is made at least primarily of a magnetic stainless steel.

13. A method of manufacturing a hard disk drive (HDD), comprising:
fitting a steel motor cup into an opening through the bottom base of an HDD enclosure;
coupling said motor cup to said bottom base; and
coupling a spindle motor to said motor cup.

14. The method of claim 13, wherein fitting said steel motor cup comprises fitting a magnetic steel motor cup into said opening.

15. The method of claim 13, wherein fitting said steel motor cup comprises fitting said steel motor cup into said opening through the bottom base of an aluminum HDD enclosure.

16. The method of claim 13, wherein fitting said steel motor cup comprises fitting said steel motor cup into said opening through the bottom base of a non-metal HDD enclosure.
